(19) United States
(12) Patent Application Publication
(10) Pub. No.: US 2008/0155429 A1
(43) Pub. Date: Jun. 26, 2008

(54) Sharing, Accessing, and Pooling of Personal Preferences for Transient Environment Customization

(75) Inventors: Alexander Frank, Bellevue, WA (US); Amit Mital, Kirkland, WA (US); Eric Horvitz, Kirkland, WA (US); Dawson Yee, Bellevue, WA (US); Miller T. Abel, Mercer Island, WA (US); Shai Guday, Redmond, WA (US); Alexander S. Stojanovic, Redmond, WA (US); Michael J. Sinclair, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/613,943

(22) Filed: Dec. 20, 2006

(51) Int. Cl. G06F 3/048

(52) U.S. Cl. 715/751

(57) ABSTRACT

Technologies for transient personal preference customization of environments, devices and systems based on user preference data. Such technologies enable users to maintain personal preference data on mobile or other devices, such as cell phones, personal data assistants (“PDA”), or the like, such that the data can be transferred to devices and systems capable of conforming parameters under their control to the preferences expressed in the data. For example, a frequent traveler may define preferences regarding room temperature, ambient lighting, music style, and the like and maintain these preferences in a mobile device such as a cell phone. Upon arrival at a hotel room, for example, the systems of the hotel may access the preference data and adjust the parameters of the room, and the devices and systems in the room, to conform to the user's preferences while the user is in the room or checked into the hotel. Such customization may be transient in that parameters may be returned to a default or other setting once a user is no longer present, or when another user is present.

### BACKGROUND

In the past, if the occupant of an office, for example, desired the temperature to be cooler, the occupant had to manually adjust the thermostat. Similarly, if dimmer lighting was desired, the occupant had to manually dim the lights. Few if any technologies have been applied to represent the environmental preferences of a user and automatically cause preference-enabled environments to conform to personal preferences when users are present in that environment. Yet people may desire greater automatic personalization of their environments and the devices and systems that they use and come in contact with. Increasing sophistication of computing devices, mobile devices, wireless connectivity, and device federations may be utilized to provide such personal preference customizations.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present specification provides technologies for transient personal preference customization of environments, devices and systems based on user preference data. Such technologies enable users to maintain personal preference data on mobile or other devices, such as cell phones, personal data assistants (“PDA”), or the like, such that the data can be transferred to devices and systems capable of conforming parameters under their control to the preferences expressed in the data. For example, a frequent traveler may define preferences regarding room temperature, ambient lighting, music style, and the like and maintain these preferences in a mobile device such as a cell phone. Upon arrival at a hotel room, for example, the systems of the hotel may access the preference data and adjust the parameters of the room, and the devices and systems in the room, to conform to the user's preferences while the user is in the room or checked into the hotel. Such customization may be transient in that parameters may be returned to a default or other setting once a user is no longer present, or when another user is present.

Many of the attendant features will be more readily appreciated as the same become better understood by reference to the following detailed description considered in connection with the accompanying drawings.

### DESCRIPTION OF THE DRAWINGS

The present description will be better understood from the following detailed description considered in connection with the accompanying drawings, wherein:

FIG. 1 is a block diagram showing example mobile devices coupled together via a network and to a personal preference customization (“PPC”) server and database or PPC data store.

FIG. 2 is a block diagram showing example mobile devices coupled together via an ad-hoc network.

FIG. 3 is a block diagram showing the elements of FIG. 2 with the addition of an example PPC proxy and related elements and an example PPC sponsor and related elements.

FIG. 4 is a bock diagram showing an example data structure or schema for use in personal preference customization.

FIG. 5 is a block diagram showing an example personal preference customization (“PPC”) source device or system.

FIG. 6 is a block diagram showing an example personal preference customization (“PPC”) sink system.

FIG. 7 is a block diagram showing an example process for applying personal preference data.

FIG. 8 is a block diagram showing an example computing environment in which the technologies described above may, at least in part, be implemented.

Like reference numerals are used to designate like parts in the accompanying drawings.

### DETAILED DESCRIPTION

The detailed description provided below in connection with the accompanying drawings is intended as a description of the present examples and is not intended to represent the only forms in which the present examples may be constructed or utilized. The description sets forth at least some of the functions of the examples and/or the sequence of steps for constructing and operating examples. However, the same or equivalent functions and sequences may be accomplished by different examples.

Although the present examples are described and illustrated herein as being implemented in a computing and networking environment, the environment described is provided as an example and not a limitation. As those skilled in the art will appreciate, the present examples are suitable for application in a variety of different types of computing and communications environments.

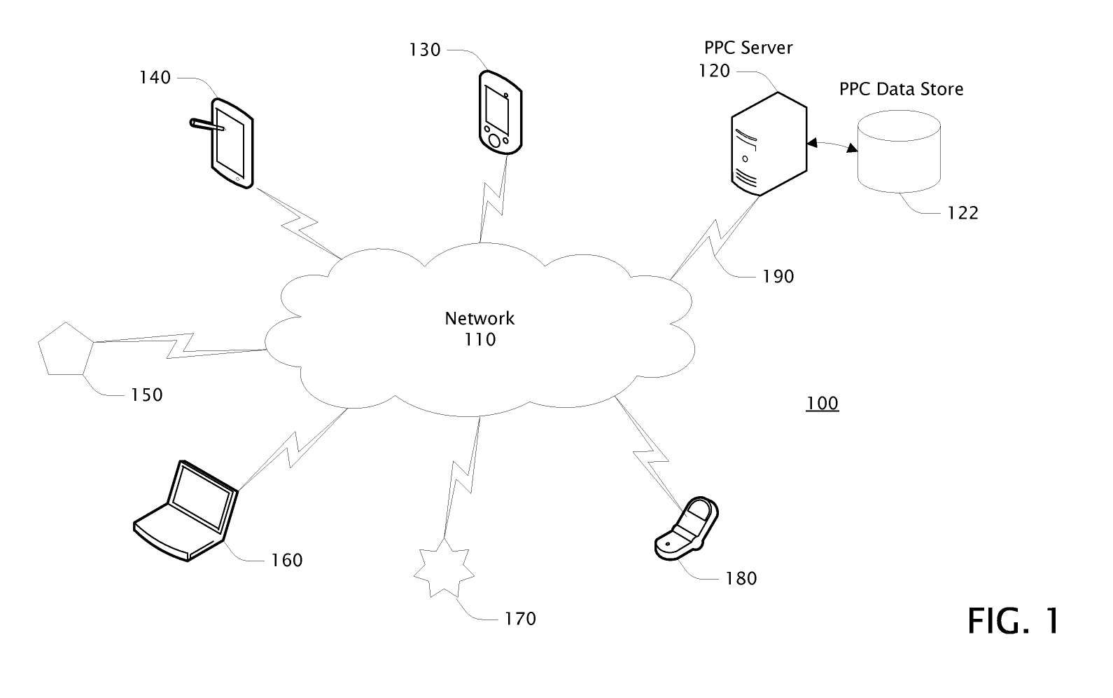

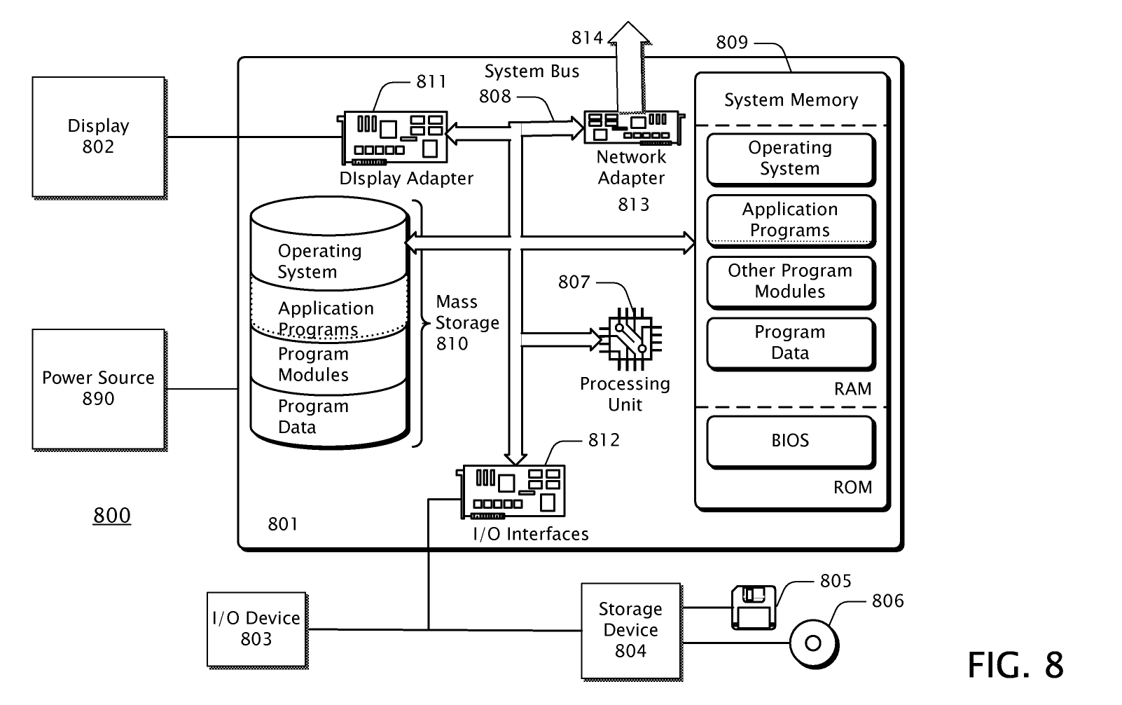

FIG. 1 is a block diagram showing example mobile devices coupled together via a network 110 and to a personal preference customization (“PPC”) server 120 and database or PPC data store 122. Example devices may include personal data assistant (“PDA”) 130, tablet personal computer (“PC”) 140, PPC sink device 150, laptop PC 160, PPC source and sink device 170, and cell phone 180. Such devices may be operable to at least determine their physical or geographic location as well as provide PPC functionality. Some such devices may include an example computing environment such as that described in connection with FIG. 8. Other types of devices may also be coupled with the forgoing devices via network 110 or other means. Such devices may include mobile devices or other devices such as desktop PCs, servers, systems, or any other type of mobile or non-mobile device that may contribute to and/or benefit from personal preference customization, Further examples of such devices include PPC-enabled memory sticks or cards, electronic badges, implanted devices, digital cameras, digital video recorders (“DVR”), vehicles or any other device, system, construct, composition, or the like operable to at least recognize and/or support personal preference customization.

Some such devices may be considered “source” devices—devices operable to source or provide personal preference (“PP”) information that may be used by sink devices. Other such devices may be “sink” devices—devices that can sink or consume and utilize PP information, such as PPC sink device 150. Further, a device may be both a source and a sink device, such as PPC source and sink device 170. For example, Bob's laptop PC, such as laptop PC 160, may include PP information indicating Bob's preference for wallpaper thus making it an example source device. Such PP information may include the wallpaper itself. This PP information may be sourced by Bob's laptop to other devices capable of supporting wallpaper, such as PDA 130 and tablet PC 140, both example sink devices, such that those devices are customized with Bob's wallpaper as Bob makes use of those devices. Bob's laptop PC may itself utilize the wallpaper preference information it contains to conform its own wallpaper settings to Bob's preferences, making it an example source and sink device.

Examples of a PPC source device may include any device, such as a mobile device, that may be carried by a person and/or may include a user's personal preference information. PPC source devices may include, but are not limited to: cell phones; cameras; PDAs; various forms of PCs; or the like; as well as other devices such as: electronic watches; electronic tags, badges, cards, or the like; radio frequency identification (“RFID”) chips or devices or other objects with such chips embedded in them; or any device or mobile device operable to participate in personal preference customization; or the like; or any combination of the foregoing.

Examples of PPC sink devices may include any device that is operable to participate in the utilizing of PP information to customize some portion of an environment, typically in a transient manner, based on PP information and a user's presence. Such PPC sink devices may include, but are not limited to: cell phones; cameras; PDAs; various forms of PCs; or the like; as well as other devices or systems such as: lighting control systems; temperature and/or environmental control systems; audio and/or video systems; seating or other ergonomic control systems; vehicles; electronic display systems; or any other device or system with aspects suitable for personal preference customization; or the like; or any combination of the foregoing. Further, a device may be both a sink device and also a source device, and/or may be a sink device at one time and a source device at another time.

Devices may be coupled to network 110 via any operable link, such as example link 190. Such links may include a network interface card (“NIC”), a serial or parallel port, a data bus, an analog interface, or the like, may be wired or wireless, and may make use of infrared (“IR”), acoustics, optics, radios frequency (“RF”), or any other suitable medium. Network 110 may be an ad-hoc network with devices coupling transiently. Server devices, such as server 120, and other non- or less-mobile devices, may be coupled to network 110 more persistently than mobile devices. In one example, network 110 may be a wireless fidelity (“Wi-Fi”) network at a municipal facility, coffee shop, city library, courtroom, or airport lounge, or may be deployed across a neighborhood, city, county or other geographic area. Mobile and other devices may typically link to such a Wi-Fi network via wireless adapters or any other suitable means. Such devices may also be operable to link to other types of networks, such as corporate networks, home networks, and/or the Internet. In another example, cell phones or other devices may link to a cellular network via appropriate RF adapters and protocols or other suitable means. Such cell phones may also be operable to link to other types of networks, such as Wi-Fi networks or the like. Network coupled devices may form and/or join federations of devices. Further, PPC devices may couple to multiple networks, federations, groups, or the like.

PPC server 120 may send and/or receive PP information to other devices coupled to network 110, may process and/or store such PP information, and may send such PP information to other devices not coupled to network 110. PPC data store 122 may be utilized by PPC server 120 to store PP data or the like including such received from various devices coupled via network 110 or otherwise coupled. In one example, PPC server 120 and database 122 may be a PPC appliance—a special-purpose device or system or the like primarily intended to provide PPC server and/or data storage functionality. Such a PPC appliance may be coupled to network 110 via any operable link, such as example link 190. Such a PPC appliance may provide a subset of PPC server and/or database functionality and/or may not be coupled to a network. Such an appliance may simply emit PPC information via RF means or acoustic means or the like.

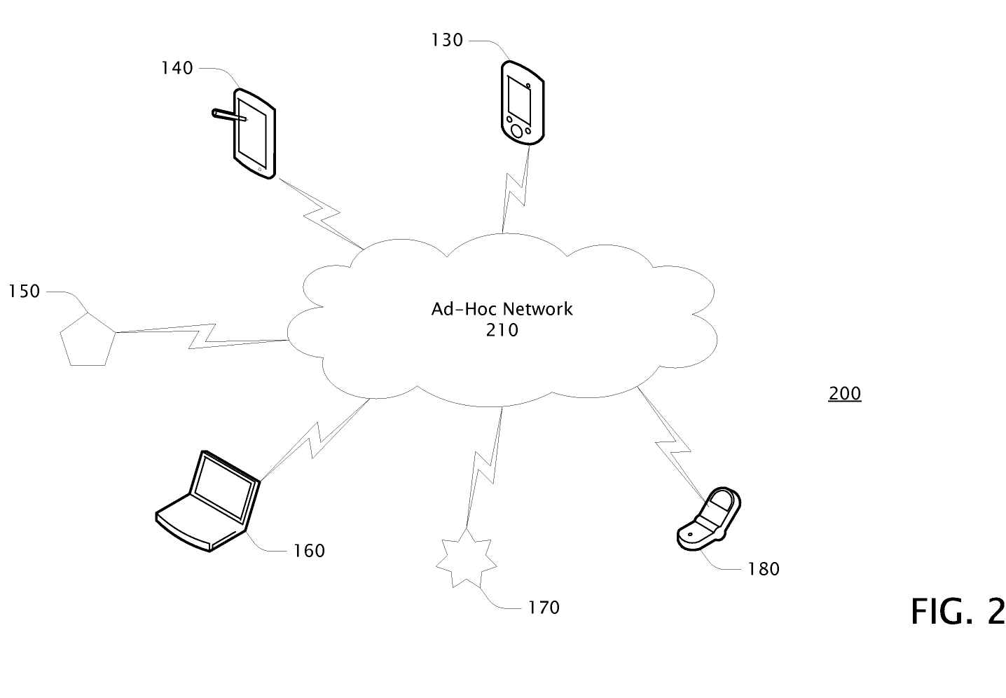

FIG. 2 is a block diagram showing example mobile devices coupled together via an ad-hoc network 210. Such an ad-hoc network may not include any persistent devices such as PPC servers or related data stores. Ad-hoc networks for PPC purposes may be formed as various mobile or other devices dynamically and/or transiently form and join such networks. For example, an ad-hoc network may be formed comprising devices of people on a particular bus or in a particular office, building, or geographic area. In another example, such an ad-hoc network may be formed comprising devices carried by members of a particular family and perhaps their friends, by members of a club, group, association, or the like, by employees of a company, etc. Alternatively or additionally, such an ad-hoc network may be formed by one or more source devices, such as a PDA, coupled with one or more sink devices, such as various environmental and/or ergonomic control systems or the like of an office, home or vehicle. Example devices shown in FIG. 2 include some of those described in connection with FIG. 1. Such an ad-hoc network may make use of the Internet, a corporate network, or any other type of network or combination of networks, communication mediums, or the like, and devices coupled via such an ad-hoc network may be separated by vast geographic distances. Ad-hoc network coupled devices may form and/or join federations of devices.

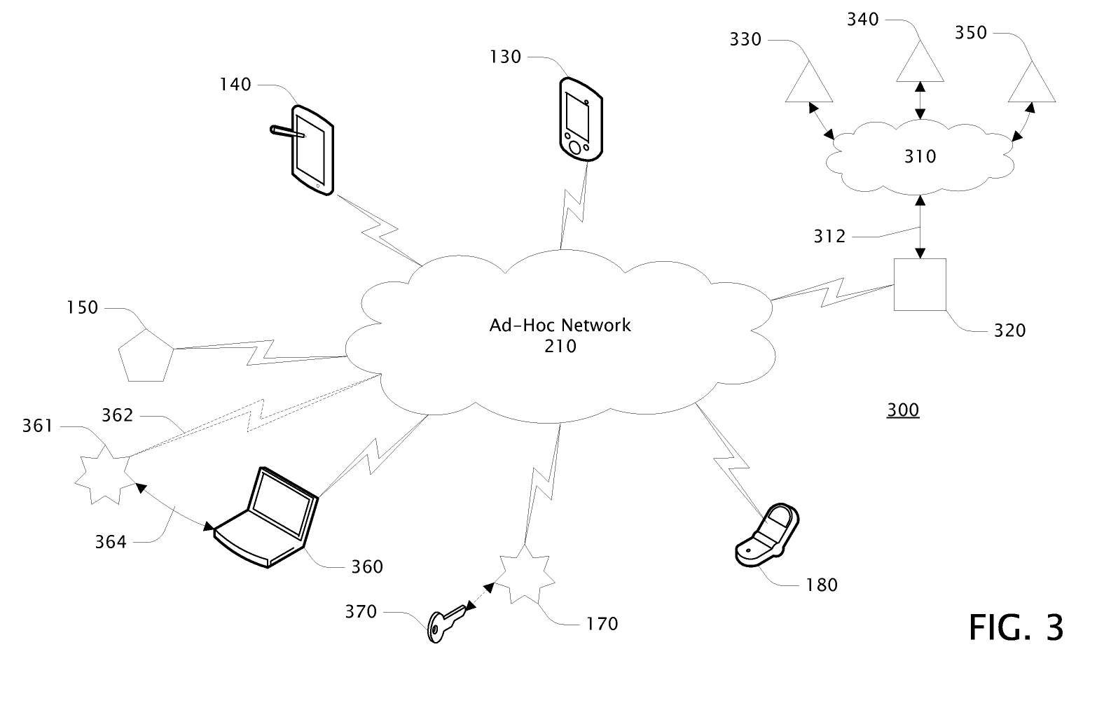

FIG. 3 is a block diagram showing the elements of FIG. 2 with the addition of an example PPC proxy 320 and related elements 310, 312, 330, 340, and 350 and an example PPC sponsor 360 and related elements 361, 362, and 364. PPC proxy 320 is typically utilized to couple devices and/or systems such as non-PPC-enabled devices to a PPC system 300, such as example devices 330, 340, and 350 shown coupled via communications medium 310 and PPC proxy 320. Example devices 330, 340, and 350 may, when combined with example PPC proxy 320, be utilized as source devices, sink devices, or both. For example, a component stereo system may include a communications bus for linking the components of the stereo system together for information exchange, control, and the like. Such a component stereo system may not be PPC-enabled. By coupling a PPC proxy, such as proxy 320, to the component stereo system via its communications bus the stereo system may be utilized as a PPC source and/or sink.

Communications medium 310 may be any mechanism sufficient to couple example devices 330, 340, and/or 350 to PPC proxy 320. In one example, medium 310 may be a communications bus, such as the communications bus of a component stereo system. In another example, medium 310 may be some form of network or the like. Links to medium 310, such as link 312, may be any suitable link.

Example laptop 360 is an example sponsor device providing coupling for PPC device 361 to PPC system 300. PPC device 361 may be capable of coupling directly to PPC system 300, as indicated by link 362, but may couple to PPC system 300 via sponsor device 360, as indicated by link 364. Multiple PPC devices, such as device 361, may couple to PPC system 300 via a sponsor device, such as example sponsor device 360. PPC device 361 may be a source device, a sink device, or both. Sponsor devices, such as sponsor device 360, may consolidate the coupling of and communication for one or more sponsored devices, such as device 361. Such consolidation may reduce the number of communication paths in a PPC system, may provide a point of security, authentication, validation, or the like, may provide a point of monitoring and/or control, or some other benefit.

Example PPC key device 370 may be utilized in connection with PPC source and/or sink devices to authorize the application of PPC data. Alternatively or additionally, example PPC key device 370 may be utilized to associate PPC data between PPC source and sink devices. For example, a hotel magnetic room key may act as a PPC key device, such as example PPC key device 370, to authorize the application of PPC data stored in a proximate mobile source device to any PPC sink devices in the corresponding hotel room. Without the PPC key device, the sink devices in the room would not respond to the PPC data in the source device. In another example, PPC data is stored in a sink device but not applied by the sink device until an appropriate key, such as example PPC key device 370, is utilized.

Situational authority may apply to PPC key devices. For example, Jim's hotel room key may act to authorize the application of his preferences in his room, but will not do the same in any other room of the hotel. But a hotel maid may carry as “master key” that causes the hotel's preferred settings to be applied in every room, even overriding the preferences of guests when the maid is present. PPC key devices may be physical or virtual.

The term “federation of devices” is generally intended to mean a grouping, collection, partnership, association, coalition, or the like of devices such that the devices may collaborate, interact, communicate, or the like via some means and for some purpose. In particular, a federation of such devices may interact for PPC purposes. A “federated device” is generally a device that is part of a federation of devices. Such as device may federate with other devices briefly or for a longer period of time. A federation of devices may be established via some formal means, such as a certificate-based log-in, or via some ad-hoc means, such as a simple request to join. The devices of such a federation of devices may collaborate, interact, communicate, or the like via means such as a network, ad-hoc network, virtual network, RF transmissions, acoustics, IR, any other suitable means, or any combination of the foregoing.

Personal preference technologies for transient environment customization generally enable a person or other entity to interact with PPC-enabled devices and/or systems to have an environment customized in various ways to conform to the preferences of the entity. In one example, Jim carries a PPC-enabled cell phone and Jim's office is also PPC-enabled. Jim's cell phone includes PP information for lighting, temperature, computer settings, phone settings, ergonomic settings, etc., and the corresponding systems in Jim's office are operable to support such PP data. As an example, when Jim enters his office with his cell phone, the cell phone joins a “PPC Jim's Office” federation or the like including the other PPC-enabled devices and systems related to Jim's office. As a PPC source device, Jim's cell phone provides the relevant PP data it contains to the other PPC-enabled devices and systems related to Jim's office. Each PPC sink device examines the PP data and applies any data relevant resulting in conformance to Jim's preferences.

For example, Jim prefers subdued lighting while in his office, and this preference is reflected in the PP data stored in his cell phone. When Jim enters his office, a PPC-enabled lighting control system adjusts the lighting to conform to the preferences indicated by Jim's PP data. Jim also prefers all phone calls to be redirected to voice mail so as to avoid the distraction of random ring tones while in the office. Jim also prefers his favorite “High Energy” wallpaper in the mornings and his “Mountain Scene” wallpaper after lunch. Jim further prefers an office temperature of 70 degrees in the morning and a cooler 66 degrees after lunch, as well as a lower chair height setting in the morning and a taller chair height setting in the afternoon. When Jim is in his office, the office lighting, the operation of his desk phone and cell phone, the wallpaper on any computers or other wallpaper-enabled devices he is using, and his chair height, are all automatically adjusted to conform to his preferences based as appropriate on the time or day, and any other conditions indicated by the PP data stored on Jim's cell phone, and propagated to any sink devices and systems relate to Jim's office.

In another example, a third-party may define a range of possible settings for a sink device. Such pre-defined settings may conform to a set of themes or standards that limit the possible settings. PP data may be used to select from among the available themes or settings. Such a selection may include a manual mapping between PP data and available settings, or the mapping made be made automatically or semi-automatically via any suitable mapping algorithm. For example, Jim may have preference data stored on his PDA indicating the color schemes he prefers when using a PC. But the PCs at a public library may have a limited set of color schemes available which do not directly map to Jim's preferences. In one example, an algorithm maps Jim's preferences to one of the available color schemes on the library PC he is using. Such algorithms may be associated with the source device, the sink device, or both.

In another example, Jim changes the afternoon wallpaper on his main desktop PC to an “Island Paradise” image and designates the image as the afternoon preference for his office. As Jim's main desktop PC is part of the “PPC Jim's Office” federation, information regarding this change is propagated to other devices and systems in the federation. Jim's cell phone, for example, is thus able to update its stored PP data to include such preference changes based on the change Jim made on his desktop PC.

In another example, Jim travels on business and rents a PPC-enabled car. Upon entering the car, Jim's PPC-enabled cell phone communicates with the car's control systems and Jim's seat position preferences, music style preferences, and lighting preferences are provided by Jim's cell phone to the car's systems. The result is that the driver's seat position, the radio stations, and the car's interior lighting are automatically adjusted to conform to Jim's personal preferences. Further, Jim's PDA includes information regarding Jim's itinerary, including his hotel reservation. Jim's PDA provides the hotel information to the car's navigation system thus providing Jim with driving directions to his hotel. Later, when Jim returns the rental car, all of Jim's PPC settings are automatically discarded.

A “control system” or “environment control system” or “PPC-enabled control system” or the like as used herein generally refers to mechanisms operable to control some aspect of some environment, either physical or virtual. A temperature control system, for example, may be capable of accepting data via some means specifying a desired temperature and adjusting the temperature (a physical aspect) to conform to that desired. A stereo may be able to accept data indicating music styles and preset stations conforming to the indicated styles. A computer may be able to accept settings for wallpaper, screen resolution, or any other configuration aspect and conform such virtual aspects to the desired settings. Such a control system includes any other system, device, mechanism or the like operable to conform aspects under its control to a specified setting. The term “environment control system” or the like refers to any device, system, or the like applied to anything capable of being controlled, physical and/or virtual.

In general, proximal environments may be customized in reaction to the PP data encoded in devices, such as mobile devices or the like. Further, such PP data may be linked to the identities of multiple people in a location. For example, a PPC-system may consider the television show preferences of a number of people and compute the television shows that would be of interest to the people in a room or near a television screen. Likewise music preferences may be combined from the PP data for a set of people driving together, and songs might be played on a car radio that best satisfy the preferences of all of the individuals traveling together. Further, preferences from one or more persons or entities may be used to filter information for rendering and display. For example, food preferences may be combined from the PP data of a set of people driving together at dinner time, and a list of restaurants best satisfying all of the individuals might be displayed on a recommendation-system screen or via any of the individual's devices.

In another example, environmental parameters of a room may be controlled based on the PP data of a set of people. For example, preferences may be viewed as “votes” or the like for preferred music or room temperature or any other parameter. A PPC system may be employed for directing the customization of the local environment based on the distribution of preferences. One approach may be to seek to optimize the overall utility of the group based on a utilitarian model. Another approach may be to allow some individuals to have more weight than others in the customization decision making. For example, the preferences of adults may have greater priority than those of children. In another example, people with authorization may be endowed with the ability to specify or modify customization criteria. Various functions or optimization routines may be utilized by a PPC system for controlling such customization decision making.

PPC systems may operate in a fully automated way and/or in a partially automated manner. For example, user confirmation prior to complying with implicit or explicit preferences may be requested via a user's mobile device. For example, a user may be asked to confirm that he would like the room warmer, the music shifted to classical, and all calls withheld during the one-on-one meeting he has listed in his calendar as active at the moment. Alternatively or additionally, a user may be presented with a menu of recommended environmental changes based on PP data along with a request for the user to confirm, select, and/or modify any of the parameters being considered by the PPC system.

In yet another example, multiple people may share their PP data via devices with a host or other key person who has the authorization necessary to request or make environmental changes via a PPC system. One of more of such hosts may receive PP data from guests, for example, and review and utilize the guest preference data so as to make sure that the guests are satisfied. PPC system functionality, such as providing visualizations and summarizations of PP data, as well as different types of optimization routines that operate over the PP data of one or more people may be employed to assist the host with understanding the preferences and with how to best customize the environment to comply with the preferences. Such PPC system functionality may also provide for notifying the hosts or others when one or more guests are not happy with a current situation or environment.

The providing of PP data may be performed anonymously. In some cases people may feel more comfortable sharing their music, room temperature, or other preferences if done anonymously, For example, for large groups of people who are sharing PP data for the customization of a local environment, devices may be configured with policies, perhaps controlled and edited by device users, that dictate how preferences are to be shared. Such policies can dictate which aspects of the PP data, and when such aspects, may be shared. For privacy reasons, a user may chose to share PP data only when there are more than some minimal number of others satisfying some criteria, the others also anonymously sharing their PP data, For example, a woman in a group largely composed of men may configure her device to share PP data only when there were at least ten other females also sharing their related PP data. Such policies may be coupled with cooperative systems that make decisions to share preferences in symphony.

Preferences may be viewed as private information. Users of a PPC system may have the ability to specify specific rules about sharing PP data. Such rules may be related to the location, the identities of other people or organizations around them, or other such criteria. For example, a user may choose to share his PP data only when all of the people around him are on his contact list. Or a user may choose to share his PP data only with a particular airline company or hotel, and block others from accessing his preference data. A user may also indicate with whom in a larger group his PP data should be shared.

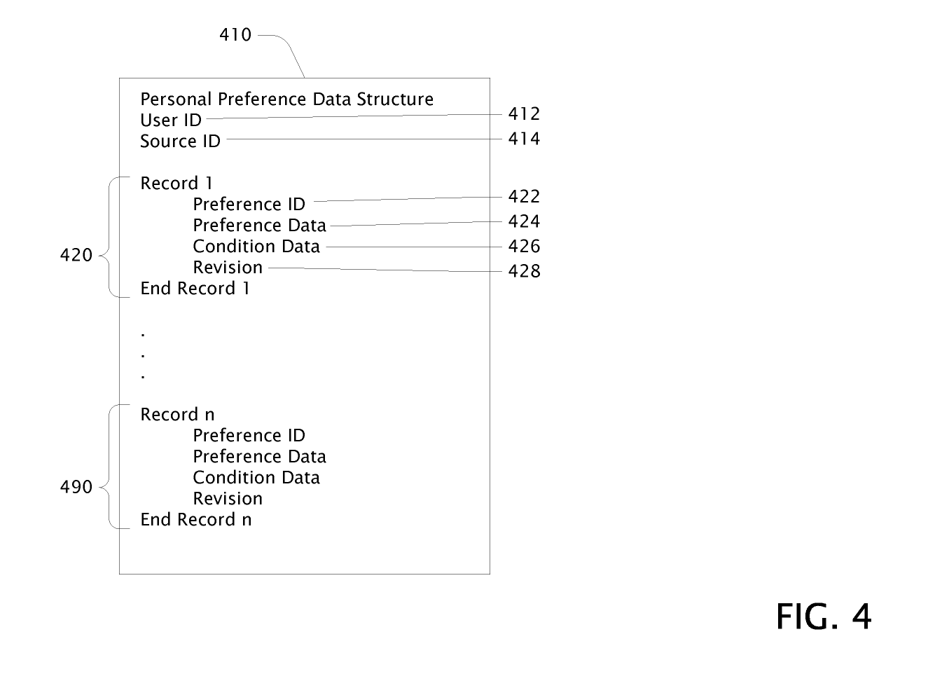

FIG. 4 is a bock diagram showing an example data structure or schema 410 for use in personal preference customization. Such a data structure may be embodied in various forms, syntaxes, structures, or the like, suitable for PPC purposes including maintaining, storing, and/or processing PP data and/or communicating PP data with other devices or systems. Such data structures may include records. The term “record” as used herein generally refers to a data structure, schema, or the like that includes one or more data elements or fields organized in some defined manner. A data structure, such as data structure 410, may include multiple records with each such record typically being discernable from any other records.

In one example, data structure 410 is embodied using extensible markup language (“XML”) or the like. In another example, such data structures may be embodied in the syntax of a programming language such as C++ or the like. In yet another example, such data structures may be embodied in or as a data base table or the like. Alternatively, such data structures may be embodied in any combination of the foregoing or the like. Such data structures may be embodied in any computer-readable format and/or stored in/on any computer-readable media. Further, such data structures may be synthesized from other data and/or sources such that the data structures need not be stored in source devices, sink devices, PPC data stores, or the like.

Example personal preference (“PP”) data structure 410 may be used by any source device to collect and store information regarding the personal preferences. PP data structure 410 may also be used by a source device to send, transmit, broadcast, or otherwise communicate PP information to other devices, including sink devices. PP data structure 410 typically includes user identification (“ID”) field 412 comprising information that uniquely identifies the user to which the PP data structure applies. In one example, user ID field 412 contains a global unique identifier (“GUID”) that uniquely identifies the user from other users. In other examples, other forms of user ID information may be used to uniquely identify a user from other users, including users participating via one or more devices in one or more federations of devices. A user may be a person, a system, a group, a device, or any other entity or the like that may benefit from preference customization of an environment.

In some instances, user ID 412 may be accompanied by various forms of security and/or account data, such as certificates, passwords, or the like. Such data may be used by a sink device or system to validate and/or authenticate a user to determine applicable rights or privileges. Users without sufficient rights or privileges may not have their personal preferences, or portions thereof, honored by such a sink device or system.

PP data structure 410 typically includes source identification (“ID”) field 414 comprising information that uniquely identifies the source device providing, maintaining, and/or storing the PP data structure. In one example, source ID field 414 includes a global unique identifier (“GUID”) that uniquely identifies the source device from other devices in a federation of devices or the like. In other examples, other forms of source ID information, such as address information, may be used to uniquely identifying the source device from other devices in one or more federations of devices or the like.

PP data structure 410 typically includes a record for each preference defined for the user identified by user ID 412, such as Record 1 through Record n, 420 and 490 respectively. In one example, each record includes preference ID field 422, preference data field 424, and condition data field 426. Further, each record typically includes revision field 528 comprising revision information for the record. In one example, such revision information includes a date and time of the most recent change to the record.

PP data structure 410 typically includes preference identification (“ID”) field 422 comprising information that uniquely identifies the preference. In one example, preference ID field 422 includes a global unique identifier (“GUID”) that uniquely identifies the preference from among other preferences. Such a preference ID may be based on a standard and/or be uniquely identifiable by PPC sink devices.

PP data structure 410 typically includes preference data field 424 comprising information establishing the parameters of a preference. For example, field 424 may include information usable by a sink device to set some environmental condition or aspect to conform to the preference. In one example, field 424 may include lighting information or the like that may be used by a lighting control system to set a lighting level to conform to a preference.

PP data structure 410 may include other fields and/or information useful in defining personal preferences and/or communicating PP data with other devices or systems. Such other information may include additional PP information, device information, user information, communication headers, check sums, time stamps, revision information, or the like.

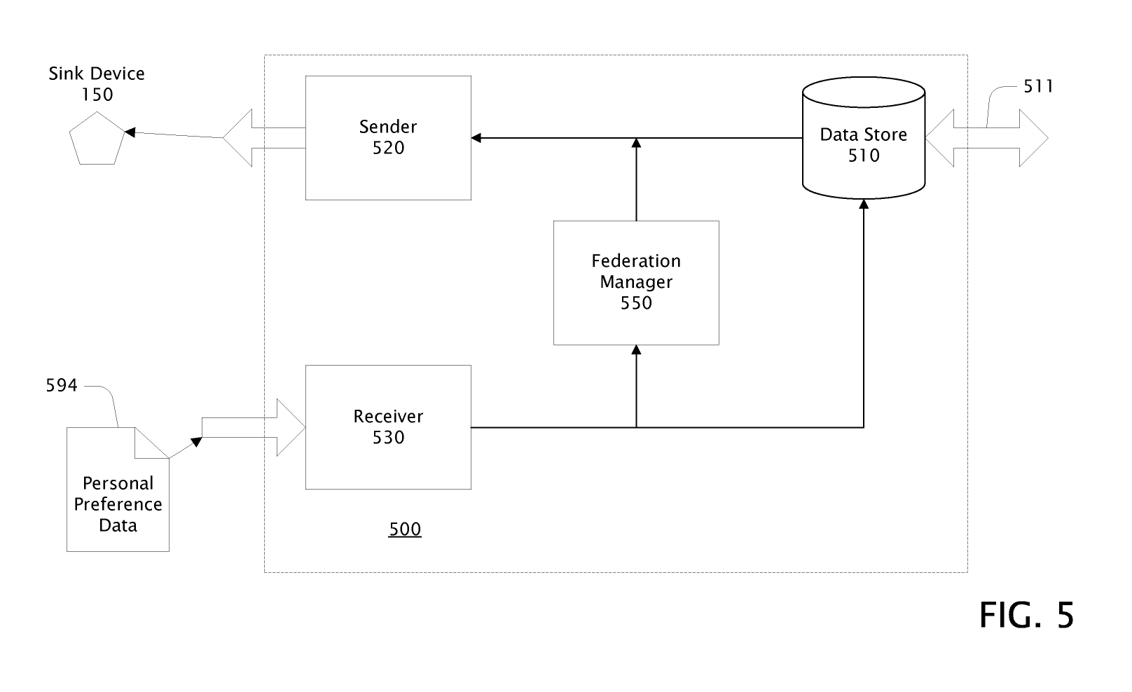

FIG. 5 is a block diagram showing an example personal preference customization (“PPC”) source device or system 500. Source system 500 may be implemented in software, hardware, firmware, or the like, or any combination of the foregoing. Source system 500 typically operates on a device such as a source device. Alternatively, source system 500 may be a distributed system with various elements operating on various devices, systems or the like. Source system 500 is comprised of elements including data store 510, interface 511, sender 520, receiver 530, and federation manager 550. Source system 500 also utilizes data structures such as PP data structure 410 described in connection with FIG. 4. Arrows shown in FIG. 5 represent example interactions and communications between elements of source system 500. Other interactions and communications may also exist between elements not represented in FIG. 5 by arrows.

Example data store 510 is a mechanism sufficient to store PP data and data structures, such as data structure 410 described in connection with FIG. 4, as well as other PP data. Data store 510 may be volatile or non-volatile and may include system memory and/or mass storage such as described in connection with FIG. 8. Data store 510 may be local to a source system or device, or remotely located.

Example interface 511 is a means for creating, updating, managing and the like personal preferences and related data. Such an interface may include appropriate user interface mechanisms and/or application and/or systems interface mechanisms.

Example sender 520 is a means for sending, transmitting, broadcasting, or the like, PP information, such as PP data structures, and/or other information or data to other devices and/or systems. Such sending may be to specific other devices and/or systems, to all devices/systems in a federation of devices or the like, to some subset of devices/systems, or to any device/system without limitation. In one example, sender 520 is a network interface that may be coupled to one or more networks. Source system 500 may send data structures, such as PP data structures, and/or other information via sender 520 to other devices/systems, such as sink device 150.

Example receiver 530 is a means for receiving, accepting, obtaining, or the like PP information, such as PP data 594, and/or other information or data from other devices or systems. PP data 594 may be equivalent to PP data structure 410 described in connection with FIG. 4. Such receiving may be from specific other devices and/or system, from all devices/systems in a federation of devices or the like, from some subset of devices/systems, or from any device/system without limitation. In one example, receiver 530 is a network interface that may be coupled to one or more networks. PP data and/or other information received by receiver 530 may be utilized to update personal preferences stored in data store 510 and/or for other purposes.

Example federation manager (“FM”) 550 is a means for forming, detecting, joining, and otherwise interacting with PPC federations or the like. In one example, FM 550 sends sufficient information via sender 520 to other devices to form a federation for PPC purposes that can be joined by the other devices. In another example, FM 550 receives sufficient information via receiver 530 such that source device 500 can detect and join federations or the like. Further, FM 550 typically detects the presence of sink devices and sends PP data structures, such as those stored in data store 510 ore the like, to such sink devices.

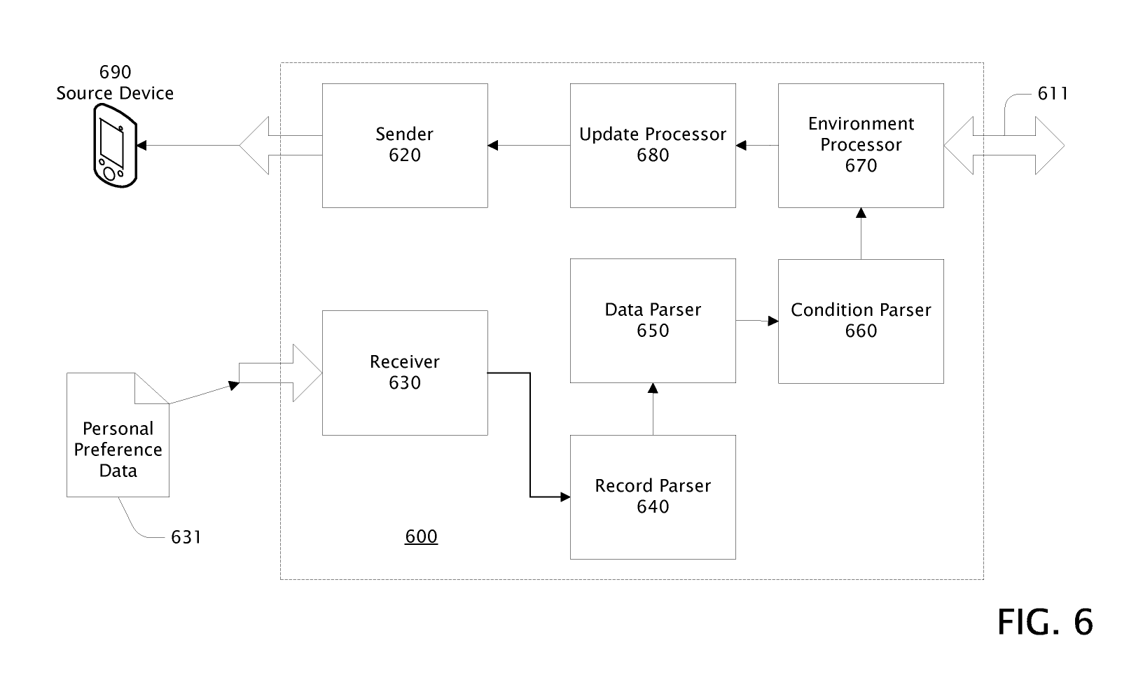

FIG. 6 is a block diagram showing an example personal preference customization (“PPC”) sink system 600. Sink system 600 may be implemented in software, hardware, firmware, or the like, or any combination of the foregoing. Sink system 600 typically operates on a device such as a sink device. Alternatively, sink system 600 may be a distributed system with various elements operating on various devices or the like. Sink system 600 is comprised of elements including sender 620, receiver 630, record parser 640, data parser 650, condition parser 660, environment processor 670, update processor 680, and environment interface 611. Sink system 600 also utilizes data structures such as PP data structure 410 described in connection with FIG. 4. Arrows shown in FIG. 6 represent example interactions and communications between elements of sink system 600. Other interactions and communications between elements may not be represented in FIG. 6 by arrows.

Example sender 620 is a means for sending, transmitting, broadcasting, or the like, PP information, such as PP data structures, and/or other information or data to other devices and/or systems. Such sending may be to specific other devices and/or systems, to all devices/systems in a federation of devices or the like, to some subset of devices/systems, or to any device/system without limitation. In one example, sender 620 is a network interface that may be coupled to one or more networks. Sink system 600 may send data, such as PP data structures, and/or other information, via sender 620 to other devices/systems, such as source device 690. For example, a user may set the temperature on a thermostat that is part of a temperature control system. The temperature setting may be sent by the control system as a preference to a source device for update, storage and/or future use.

Example receiver 630 is a means for receiving, accepting, obtaining, or the like PP information, such as PP data 631, and/or other information or data from other devices and/or systems. PP data 631 may be equivalent to PP data structure 410 described in connection with FIG. 4. Such receiving may be from specific other devices and/or systems such as source systems, from all devices/systems in a federation of devices or the like, from some subset of devices/systems, or from any device/system without limitation. In one example, receiver 630 is a network interface that may be coupled to one or more networks. PP data and/or other information received by receiver 630 may be utilized for customizing environment settings or the like in conformance to the PP data.

Example record parser 640 is a means for parsing PP data structures or the like for individual personal preference records, such as record 420 described in connection with FIG. 4. Record parser 640 typically identifies records applicable to sink system 600 and extracts relevant information from such records. For example, each record may include a preference ID indicating the personal preference type represented by the record. Such preference IDs may be used to determine if the preference is supported by sink system 600.

Example data parser 650 is a means for parsing extracted record information, as typically provided by record parser 640, for preference data. For example, such extracted record information may include preference data providing specific parameters and other relevant data for the preference. Data parser 650 typically parses preference data such that it can be applied to the environment controlled by sink system 600.

Example condition parser 660 is a means for parsing extracted record information, as typically provided by record parser 640, for preference conditions. For example, such extracted record information may include preference conditions providing conditional parameters that apply to the application of preference data. Condition parser 660 typically parses condition data such that the conditions can be factored into the application of corresponding preference data to aspects of the environment controlled by sink system 600.

Example environment processor 670 is a means for setting the environment controlled by sink system 600 to conform to preference data and conditions extracted from applicable personal preference records. For example, environment processor 670 may be a light dimmer control mechanism operable to control the brightness of an office light such that it can be made to conform to the brightness preference expressed in a personal preference record. Interface 611 is a means for, among other things, coupling sink device 600 to an environment control system, such as the light dimmer mechanism, such that a sink device can provide appropriate control information and/or signals to the control system. In one example, sink system 600 is a device that is physically distinct from the environment control system. In another example, both the sink system and the environment control system are integrated parts of the same system, device, or the like.

Example update processor 680 is a means for promoting the updating of personal preference information based on settings or changes made to an environment setting via some control system including forwarding such updates to a source device or the like. For example, a user may set a temperature via a thermostat that is part of a temperature control system. The user-established temperature setting is typically provided to update processor 680 via interface 611 and environment processor 670. Update processor 680 generally formats the user-established temperature setting in the form of PP data and sends the data to a source device or the like.

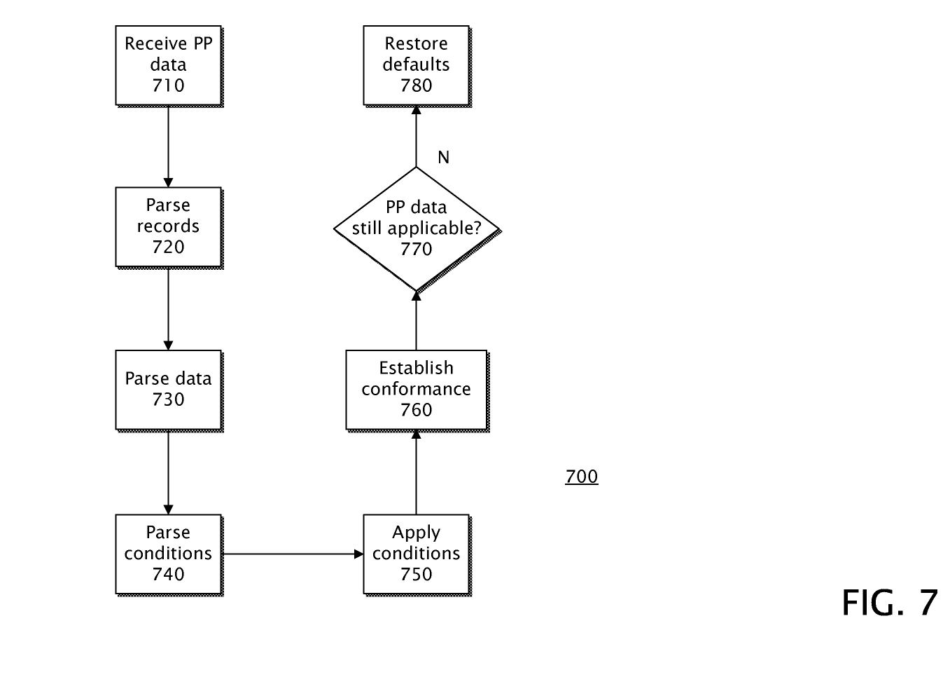

FIG. 7 is a block diagram showing an example process 700 for applying personal preference data. Such a process is typically utilized by a sink device or system to establish conformance to PP data where and/or to the extent applicable.

Block 710 indicates an example sink device receiving or otherwise obtaining PP data, typically in the form of PP data structure 410 as described in connection with FIG. 4. The sink device may optionally evaluate the source of the PP data and/or the user ID of the PP data to determine if the PP data should be further processed. Some sink devices or systems may be configured to reject or ignore PP data from certain devices or users. Once PP data is received by the sink device, process 700 typically continues at block 720.

Block 720 indicates parsing the received PP data to access any preference records in the data. Each such record is typically evaluated to determine if the specified preference, typically indicated via a preference ID or the like, is applicable to the sink device. For example, a lighting control system may be able to honor an ambient lighting preference but may not be able to honor a music type preference. Further, the lighting control system may not honor an ambient lighting preference due to a failed authorization or validation attempt, or insufficient user or device rights or the like. Once a record is parsed and accepted for further processing, process 700 typically continues at block 730.

Block 730 indicates parsing preference data from an accepted record. Preference data generally includes the information required for a sink device to establish conformance to the preference. For example, a temperature preference record may include data that specifies a desired ambient temperature of 70 degrees such that the data can be used by a temperature control system or the like. In another example, record data may include a wallpaper file such that a wallpaper supporting device, such as a PC, can utilize the wallpaper file includes in the data and apply it according to the preference. As or after record data is parsed, process 700 typically continues at block 740.

Block 740 indicates parsing condition data from an accepted record. Preference conditions generally include information used to determine if, when, how, and/or other conditions by which preference data is to be applied. For example, a temperature preference record may include conditions that specify a desired ambient temperature of 70 degrees before noon on any given day, and 66 degrees from noon on. In other examples, conditions may include logic, script, code, executable sequences, or the like. In yet other examples, a representation of any condition or combination of conditions that may be of value for the data of a particular preference may be included. Conditions may be evaluated by a sink device or system and/or by an environment control system or the like, or any combination of the foregoing. Once any preference conditions have been parsed, process 700 typically continues at block 750.

Block 750 indicates applying any conditions to the preference data. For example, given a temperature preference record that includes conditions that specify a desired ambient temperature of 70 degrees before noon on any given day, and 66 degrees from noon on, the current time is typically evaluated to determine which of the temperature settings apply. Further, conditions are evaluated via an appropriate means such that the appropriate temperature preference is determined at the appropriate time. In other examples, conditions are processed or evaluated as appropriate so as to determine the applicable preference data. Once the data to be applied has been determined, process 700 typically continues at block 760.

Block 760 indicates establishing conformance to the personal preference based on the preference data and conditions. This is typically accomplished by applying the determined preference data and any conditions to an appropriate environment control system or the like. For example, when Bob enters his office with a personal temperature preference of 70 degrees, this preference is applied to the office's temperature control system which sets the office temperature to conform to the preference. Process 700 typically continues at block 770.

Block 770 indicates determining whether a personal preference is still applicable. A preference may cease to be applicable for at least two reasons. First, a condition of the preference may result in the preference changing or ceasing to apply. In this case, the steps detailed in blocks 750 and 760 are reapplied. Second, the user may leave the environment such that the user's personal preferences no longer apply to the environment. For example, Bob may leave his office resulting in his personal temperature preference no longer applying to the office. Or Bob may log off a wallpaper-enabled PC resulting in his wallpaper preference no longer applying to the computer. “Leaving the environment” may include: a change in physical or geographical location, such as leaving an office; logging off or the like; a relevant time period ending, such as reaching a hotel room checkout time; or some other relevant event or condition such that the PP data no longer applies. Once it is determined that the PP data no longer applies due to leaving the environment, process 700 typically continues at block 780.

Block 780 indicates restoring default settings or the like once a preference no longer applies. The restored settings could be default settings, previous settings, or some other settings. In some examples, this restoring step may be skipped. For example, a hotel may configure a temperature control system to, by default, neither heat nor cool a room in order to reduce costs when the room is not occupied. As a guest enters the room, the control system may conform to the guest's temperature preference. When the guest leaves the room, the control system may restore the hotel's default. Alternatively, the hotel may configure the control system to maintain conformance to a guest's preference, once set, until the guest's checkout time is reached, or until the guest leaves the room after the checkout time is reached, and then restore the default temperature setting.

FIG. 8 is a block diagram showing an example computing environment 800 in which the technologies described above may, at least in part, be implemented. A suitable computing environment may be implemented with numerous general purpose or special purpose systems. Examples of well known systems may include, but are not limited to, cell phones, personal digital assistants (“PDA”), personal computers (“PC”), hand-held or laptop devices, microprocessor-based systems, multiprocessor systems, servers, workstations, consumer electronic devices, set-top boxes, and the like.

Computing environment 800 typically includes a general-purpose computing system in the form of a computing device 801 coupled to various components, such as peripheral devices 802, 803, 804 and the like. System 800 may couple to various other components, such as input devices 803, including voice recognition, touch pads, buttons, keyboards and/or pointing devices, such as a mouse or trackball, via one or more input/output (“I/O”) interfaces 812. The components of computing device 801 may include one or more processors (including central processing units (“CPU”), graphics processing units (“GPU”), microprocessors (“μP”), and the like) 807, system memory 809, and a system bus 808 that typically couples the various components. Processor 807 typically processes or executes various computer-executable instructions to control the operation of computing device 801 and to communicate with other electronic and/or computing devices, systems or environment (not shown) via various communications connections such as a network connection 814 or the like. System bus 808 represents any number of several types of bus structures, including a memory bus or memory controller, a peripheral bus, a serial bus, an accelerated graphics port, a processor or local bus using any of a variety of bus architectures, and the like.

System memory 809 may include computer readable media in the form of volatile memory, such as random access memory (“RAM”), and/or non-volatile memory, such as read only memory (“ROM”) or flash memory (“FLASH”). A basic input/output system (“BIOS”) may be stored in non-volatile or the like. System memory 809 typically stores data, computer-executable instructions and/or program modules comprising computer-executable instructions that are immediately accessible to and/or presently operated on by one or more of the processors 807.

Mass storage devices 804 and 810 may be coupled to computing device 801 or incorporated into computing device 801 via coupling to the system bus. Such mass storage devices 804 and 810 may include non-volatile RAM, a magnetic disk drive which reads from and/or writes to a removable, non-volatile magnetic disk (e.g., a “floppy disk”) 805, and/or an optical disk drive that reads from and/or writes to a non-volatile optical disk such as a CD ROM, DVD ROM 806. Alternatively, a mass storage device, such as hard disk 810, may include non-removable storage medium. Other mass storage devices may include memory cards, memory sticks, tape storage devices, and the like.

Any number of computer programs, files, data structures, and the like may be stored in mass storage 810, other storage devices 804, 805, 806 and system memory 809 (typically limited by available space) including, by way of example and not limitation, operating systems, application programs, data files, directory structures, computer-executable instructions, and the like.

Output components or devices, such as display device 802, may be coupled to computing device 801, typically via an interface such as display adapter 811. Output device 802 may be a liquid crystal display (“LCD”). Other example output devices may include printers, audio outputs, voice outputs, cathode ray tube (“CRT”) displays, tactile devices or other sensory output mechanisms, or the like. Output devices may enable computing device 801 to interact with human operators or other machines, systems, computing environments, or the like. A user may interface with computing environment 800 via any number of different I/O devices 803 such as a touch pad, buttons, keyboard, mouse, joystick, game pad, data port, and the like. These and other I/O devices may be coupled to processor 807 via I/O interfaces 812 which may be coupled to system bus 808, and/or may be coupled by other interfaces and bus structures, such as a parallel port, game port, universal serial bus (“USB”), fire wire, infrared (“IR”) port, and the like.

Computing device 801 may operate in a networked environment via communications connections to one or more remote computing devices through one or more cellular networks, wireless networks, local area networks (“LAN”), wide area networks (“WAN”), storage area networks (“SAN”), the Internet, radio links, optical links and the like. Computing device 801 may be coupled to a network via network adapter 813 or the like, or, alternatively, via a modem, digital subscriber line (“DSL”) link, integrated services digital network (“ISDN”) link, Internet link, wireless link, or the like.

Communications connection 814, such as a network connection, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, [electromag induction (RFID or the like)] or other wireless communications mechanisms.

Power source 890, such as a battery or a power supply, typically provides power for portions or all of computing environment 800. In the case of the computing environment 800 being a mobile device or portable device or the like, power source 890 may be a battery. Alternatively, in the case computing environment 800 is a desktop computer or server or the like, power source 890 may be a power supply designed to connect to an alternating current (“AC”) source, such as via a wall outlet.

Some mobile devices may not include many of the components described in connection with FIG. 8. For example, an electronic badge may be comprised of a coil of wire along with a simple processing unit 807 or the like, the coil configured to act as power source 890 when in proximity to a card reader device or the like. Such a coil may also be configure to act as an antenna coupled to the processing unit 807 or the like, the coil antenna capable of providing a form of communication between the electronic badge and the card reader device. Such communication may not involve networking, but may alternatively be general or special purpose communications via telemetry, point-to-point, RF, IR, audio, or other means. An electronic card may not include display 802, I/O device 803, or many of the other components described in connection with FIG. 8. Other mobile devices that may not include many of the components described in connection with FIG. 8, by way of example and not limitation, include electronic bracelets, electronic tags, implantable devices, and the like.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code, data, applications, programs, display imagery, or the like maintained in an electronic device such as a ROM. The term “software” generally refers to executable instructions, code, data, applications, programs, display imagery, or the like maintained in or on any form of computer-readable media. The term “computer-readable media” typically refers to system memory, storage devices and their associated media, and the like.

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

1. A method for establishing conformance of an aspect of an environment to personal preference data of a user, the method comprising:
receiving the personal preference data;
parsing the personal preference data for a preference type, preference data and preference conditions; and
establishing conformance of the aspect of the environment to the personal preference data.

2. The method of claim 1 further comprising applying the preference conditions to the preference data prior to establishing conformance to the personal preference data.

3. The method of claim 1 further comprising:
determining if the personal preference data is still applicable by determining if the user has left the environment; and
if the user has left the environment, restoring a default of the aspect of the environment.

4. The method of claim 1 wherein the personal preference data is of a plurality of users and the personal preference data is processed so as to maximize conformance to the personal preference data.

5. The method of claim 1 wherein the establishing conformance is triggered by a key device.

6. The method of claim 1 embodied as computer-executable instructions on a computer-readable medium.

7. A sink system for personal preference customization, the sink system comprising:
a receiving means operable to receive personal preference data;
a parsing means coupled to the receiving means and operable to parse the personal preference data; and
an environment processing means operable to conform an aspect of an environment to the personal preference data.

8. The sink system of claim 7 further comprising a record parser operable to extract a preference record from the personal preference data.

9. The sink system of claim 8 wherein the record parser determines a preference type associated with the preference record.

10. The sink system of claim 9 wherein the record parser determines if the record type is applicable to the environment.

11. The sink system of claim 8 further comprising a data parser operable to extract preference data from the preference record;

12. The sink system of claim 11 further comprising a condition parser operable to extract preference conditions from the preference record.

13. The sink system of claim 12 wherein the environment processing means applies the preference conditions to the preference data.

14. The sink system of claim 7 further comprising an update processing means operable to accept a setting to the aspect of the environment and communicate the setting to a source device.

15. The sink system of claim 7 wherein the environment processing means interfaces with an environment control system.

16. A source system for personal preference customization, the source system comprising:
a sending means operable to send personal preference data to a sink device;
a data store operable to store the personal preference data; and
a federation manager operable to form a federation including the source system and the sink device.

17. The source system of claim 16 further comprising a receiving means operable to receive update personal preference data.

18. The source system of claim 16 wherein the personal preference data includes one or more records, each record including a preference type, preference data, and optional preference conditions.

19. The source system of claim 16 further comprising an interface operable to provide for the creation, update, and management of the personal preference data.

20. The system of claim 16 wherein the federation manager automatically sends the personal preference data to the sink device.
